(19) United States
(12) Patent Application Publication
(10) Pub. No.: US 2011/0208571 A1
(43) Pub. Date: Aug. 25, 2011

(54) Beverage Advertising Models

(76) Inventors: John T. Ballatine, Columbia Heights, MN (US); Matthew J. Ferrara, Mendota Heights, MN (US)

(21) Appl. No.: 13/030,864

(22) Filed: Feb. 18, 2011

Related U.S. Application Data
(60) Provisional application No. 61/306,197, filed on Feb. 19, 2010.

(51) Int. Cl. G06Q 30/00

(52) U.S. Cl. 705/14.15

(57) ABSTRACT

A method for implementing an advertising campaign to sell alcoholic beverages can include receiving, at a computing device, a request from a user for a tracking code associated with a purchase of an alcoholic beverage. The method an also include generating the tracking code, and sending, by the computing device, the tracking code to the user. The method can further include receiving confirmation of the purchase of the alcoholic beverage, and providing an incentive to the user for the purchase.

### RELATED APPLICATION

This application claims the benefit of U.S. Patent Application Ser. No. 61/306,197, filed on Feb. 19, 2010 and entitled “Beverage Advertising Models,” the entirety of which is hereby incorporated by reference.

### BACKGROUND

Even in good economic environments, consumers look to increase their buying power through rebates and other promotions. In the current economy, more people are entertaining in their homes, so alcohol purchases in liquor stores are increasing. Rising popularity in food television and classes has started a complementary rise in American interest in “mixology” and wine tasting.

Use of cell phones is also on the rise. People rely on their cell phones now for a myriad of reasons: voice and text communication, navigation, organization, entertainment, current events—and trends suggest mobile phone users will increasingly rely on their cell phones for purchases. Recent statistics show that while print coupons have historically had redemption rates of less than 1 percent, the young mobile coupon industry is seeing rates of 5-15 percent.

### SUMMARY

In one aspect, a method for implementing an advertising campaign to sell alcoholic beverages includes: receiving, at a computing device, a request from a user for a tracking code associated with a purchase of an alcoholic beverage; generating the tracking code; sending, by the computing device, the tracking code to the user; receiving confirmation of the purchase of the alcoholic beverage; and providing an incentive to the user for the purchase.

In another aspect, a method for implementing an advertising campaign to sell alcoholic beverages includes: generating, by a computing device, a tracking code; populating the tracking code in a device; packaging the device with an alcoholic beverage; receiving confirmation of a purchase of the alcoholic beverage by a user upon receipt of the tracking code; and providing an incentive to the user for the purchase.

In yet another aspect, a method for implementing an advertising campaign to sell alcoholic beverages includes: receiving a request from a supplier to create the advertising campaign; receiving, at a computing device using text messaging, a request from a user for a tracking code associated with a purchase of an alcoholic beverage; generating the tracking code; sending, by the computing device using text messaging, the tracking code to the user; receiving confirmation of the purchase of the alcoholic beverage; providing an incentive to the user for the purchase; and receiving payment for the incentive from the supplier.

### DESCRIPTION OF THE FIGURES

FIG. 1 shows a first example method for developing an advertising campaign and selling alcoholic beverages to consumers.

FIG. 2 shows a second example method for developing an advertising campaign and selling alcoholic beverages to consumers.

FIG. 3 shows an example computing environment programmed to allow suppliers, retailers, and consumers to participate in advertising campaigns.

### DETAILED DESCRIPTION

Various embodiments will be described in detail. Reference to various embodiments does not limit the scope of the possible claims. Additionally, any examples set forth in this specification are not intended to be limiting and merely set forth some of the many possible embodiments for the possible claims.

Generally, embodiments described herein relate to systems and methods for providing rebates, sweepstakes, or other incentive to consumers that purchase products, such as alcoholic beverages.

Although the examples provided below are directed at the purchase of alcoholic beverages, the examples are equally applicable to the purchase of other goods or services. For examples, the systems and methods described herein are equally applicable to the non-alcoholic and food industries as well.

From a user's or consumer's point of view, the systems and methods involve several easy to perform steps. Initially, the consumer requests and receives a tracking code relating to a product, such as an alcoholic beverage, prior to purchase. This can be accomplished, for example, through an exchange of text messages using a cellular phone or other device. Next, the consumer purchases the beverage and the establishment that sold the beverage records the tracking code. Finally, the consumer creates an online account using the tracking code. The online account allows the consumer to track incentives and promotions associated with the consumer's purchases and additional offers for the consumer.

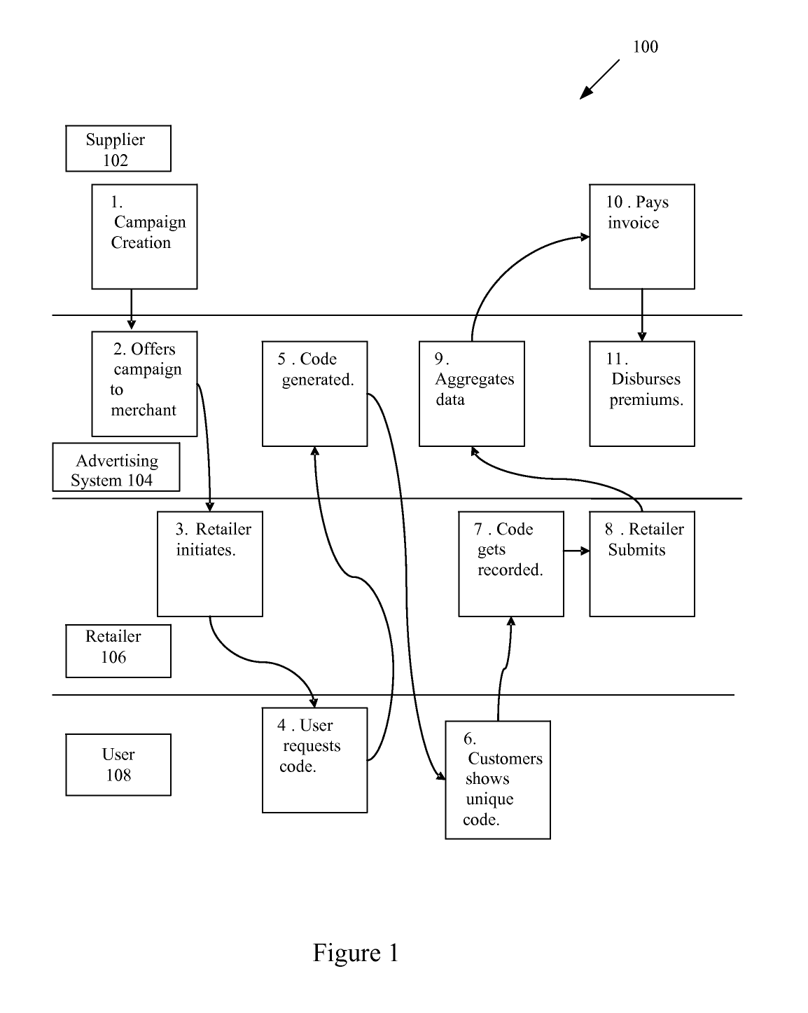

Referring now to FIG. 1, one embodiment of a method 100 for developing an advertising campaign and selling alcoholic beverages to consumers is shown. In this example, the product is an alcoholic beverage, such as beer, wine, liquor, etc. This embodiment leverages popular technology and an understanding of how state and federal laws impacts cooperation between retailers, distributors, and suppliers to create effective and scalable turnkey measured media campaigns.

In the example method 100, different parties perform different aspects of the method.

A supplier 102 is an entity that supplies an alcoholic beverage, such as a beer or liquor distributor.

An advertising system 104 is an entity that provides advertising services to sell the alcoholic beverage, such as an advertising agency. In examples provided herein, the advertising system 104 includes an online system that is accessible through a network, such as the Internet. Users of the advertising system 104, such as suppliers, retailers, and consumers, can create accounts on the advertising system 104.

The advertising system 104 allows the different entities to perform various tasks. For example, suppliers can initiate campaigns using the system, and retailers can review and decide whether or not to participate in certain campaigns. In addition, consumers can access the advertising system 104 to track rebates or other incentives and to learn about new offers located in their area, as described further below.

A retailer 106 is an entity that sells the alcoholic beverage to consumers, such as a store, bar, restaurant, etc.

Finally, a user 108 is an entity, such as a person, that purchases the alcoholic beverage. A single entity can perform multiple roles. For example, the supplier 102 and advertising system 104 can be combined into a single entity. In the method 100, the role of each entity is illustrated.

Specifically, in Step 1 of the method 100, the campaign is created. The supplier 102 can decide how long a campaign will run, the look of the advertising materials, how many purchases are required for the consumer, and premiums or incentives the supplier wants to give to the consumer if the consumer completes the required number of purchases. The supplier then submits the campaign through the advertising system 104.

In one example, the advertising materials include a shelf talker, which is a printed card or other sign attached to a store shelf to call consumers' attention to the beverage. In this example, the shelf talker can include the name of the product, information about the rebate, promotion, or other incentive, and information about where a text message is to be sent to obtain a tracking code. The tracking code can be a text string, including letters and/or numbers. In one example, the text string uniquely identifies the specific request.

Next, in Step 2, the campaign is presented to retailers within the advertising system 104 preexisting retailer network. The retailer 106 can then decide whether or not they are interested in participating in the campaign.

At Step 3, if the retailer 106 decides to participate, it can print out tracking sheets, get shelf talkers from the supplier 102, and list themselves on the advertising system user interface as a retailer that is participating. The campaign that the retailer 106 initiates will be publicly viewable to users that are logged into their advertising system account if they are within a close radius to the retailer.

At Step 4, a user 108 that shops in retail locations requests a unique code by sending a text message including a unique keyword to our short code inside a retail location. The user can also request a unique code online prior to store entry or via cell phone.

At Step 5, a dynamically generated code is created by the advertising system 104 and is sent back to the user's cell phone. This data of the user's cell phone is stored in the advertising system 104 instantaneously.

At Step 6, the user shows the code at the time of the purchase of the associated product to the retailer 106.

At Step 7, the retailer 106 records the unique code for its records on either a tracking sheet or other paper or electronic means.

At Step 8, the retailer 106 submits the redemption codes back to the advertising system 104 by various means, such as by faxing the tracking sheet, entering the codes online through their retailer account, or mailing the tracking sheet in, etc.

At Step 9, the advertising system 104 aggregates the data of text message sends versus redemptions for the supplier 102 and sends an invoice to the supplier 102. Once the redemption is submitted, the user 108 will see it on the user's advertising system interface that the user's purchase has been verified.

At Step 10, the supplier 102 pays the invoice.

Finally, at Step 11, the advertising system 104 sends out premiums to the user 108 and also pays handling fees for retailer submissions of tracking codes.

In some examples, the premiums could include coupons and vouchers for beverages at various retail locations. In some examples, the beverages correspond to the brand or brands of the sponsoring supplier. The retail locations that accept such coupons or vouchers could include those at which the consumer originally purchased the beverages, or could include other establishments, such as restaurants and bars. Allowing the coupons or vouchers to be used at other establishments, such as restaurants and bars, can help to build brand community and drive product movement at different distribution points.

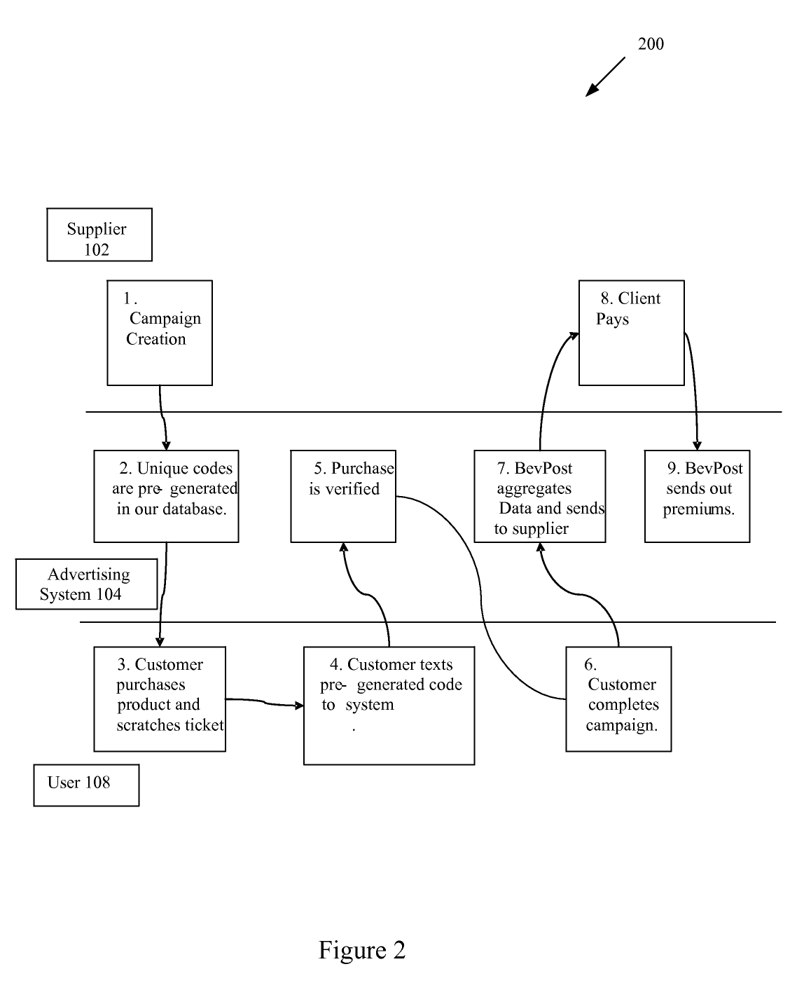

Referring now to FIG. 2, an alternative embodiment for developing an advertising campaign and selling alcoholic beverages to consumers is shown in a method 200. The method 200 is similar to the method 100 described above, with the noted differences below.

In this embodiment, the supplier 102 submits a scratch ticket inside a packaged and sealed case for individual consumption that the user 108 will have access to after purchasing. The user 108 scratches the ticket and is presented with a unique code. The user 108 sends this unique code via text message to the advertising system 104 to verify the purchase.

More specifically, at Step 1 of the method 200, the campaign is created. This is where the supplier 102 decides how long the campaign will run, how many cases it wants to run the program with, requests Scratch cards to be created, determines premiums or incentives it wants to give to consumers if the consumers complete the required number of purchases, etc.

At Step 2, the advertising system 104 creates pre-generated unique codes depending on the scope of the campaign. This is then combined with scratch cards and placed in with packaged product, such as beverage boxes. The product is then distributed to retail locations.

At Step 3, the user 108 purchases the product inside a retail location.

At Step 4, the user 108 scratches off the scratch card. The user 108 sends a unique code to the advertising system 104.

At Step 5, the purchase is deemed verified by the advertising system 104 instantaneously. This will automatically show up in the individual users interface as a purchased product.

At Step 6, the user 108 is required to complete the number of purchases the supplier requests. For example, the user may be required to purchase a certain number of beverages within a given time to qualify for a certain rebate or other incentive.

At Step 7, the advertising system 104 aggregates this data and sends an invoice to the supplier 102 for any rebates and/or other incentives that are due to users.

At Step 8, the supplier 102 pays the invoice.

At Step 9, the advertising system 104 sends out premiums to the user 108.

In one example, suppliers, retailers and consumers view different accounts via the advertising system 104. The supplier creates a campaign from their account, which is made available for retailers to offer. The distributor sales force is notified of the campaign and is given the point of purchase displays that allow a user to enroll in campaigns in the actual store.

One example of such an embodiment is provided below. In this example, a 3 by 4 shelf talker is configured to be placed in front of a bottle of 45th parallel vodka. When the user selects a bottle of 45^{th} parallel vodka to purchase, the user can access the code on the shelf talker. Once the user sends the text to their phone, the user is notified of the details of the campaign. This also allow the distributor sales force to try and get the retailer to pick up additional cases of the product or if the retailer doesn't carry the product they can use this as a tool to get their product shelf space.

The supplier is able to declare the reimbursement amount for the campaign and set whatever sort of limits it would like. Using the advertising system's built-in messaging system, the supplier can message retailers to notify them about available campaigns or for general communication.

The consumer does not have to create an account to participate in the campaign in the actual store. However, if the consumer goes online to get a rebate, the consumer is required to create an account. In the registration process, certain user information can be obtained, including: Name; Birth date; Address; Mobile phone number; and E-mail. Other information could include: Education; Marital status; Income; Gender; and Ethnicity. Less or more information can be collected.

The user account allows the system to populate relevant stores based on location, making the sending of relevant campaign information fast, and giving the ability to track user behavior. The demographic information that is collected in the registration process enables the advertising system to provide data reports to manufacturers for their products. Based on user-seeking behavior, the advertising system can define demographics efficiently.

In one example, when the user redeems with the retailer, the user shows a 5-digit code, the retailer records the unique tracking code and enters it back into our system. The advertising system tracks redemption and bill manufacturers for any sort of reimbursement due to retailers or rebates sent out to consumers.

The advertising system is scalable. From a technological standpoint, the advertising system can enter new markets efficiently. Once a manufacturer is signed on, the advertising system can take a sustainable campaign and scale it through their distribution sales force in multiple states. The advertising system makes sure the sales force is aware of how to set up the point of purchase displays, which is something they already do on a weekly basis with their retailer accounts.

In the examples provided above, the costs to the retailer and user for participating are typically negligible. The manufacturer typically pays the costs of setting up an account on the advertising system. In addition, in some examples, the manufacturer pays a fixed or per-transaction fee for use of the advertising system. For example, in some embodiments, the manufacturer pays an amount per transaction, or pays an amount for each text message that is send to a consumer. Other configurations are possible.

In example embodiments, one or more of the steps of the methods 100, 200 can be implemented on one or more computing devices. In some embodiments, the steps performed by at least the advertising system are implemented on one or more computing devices.

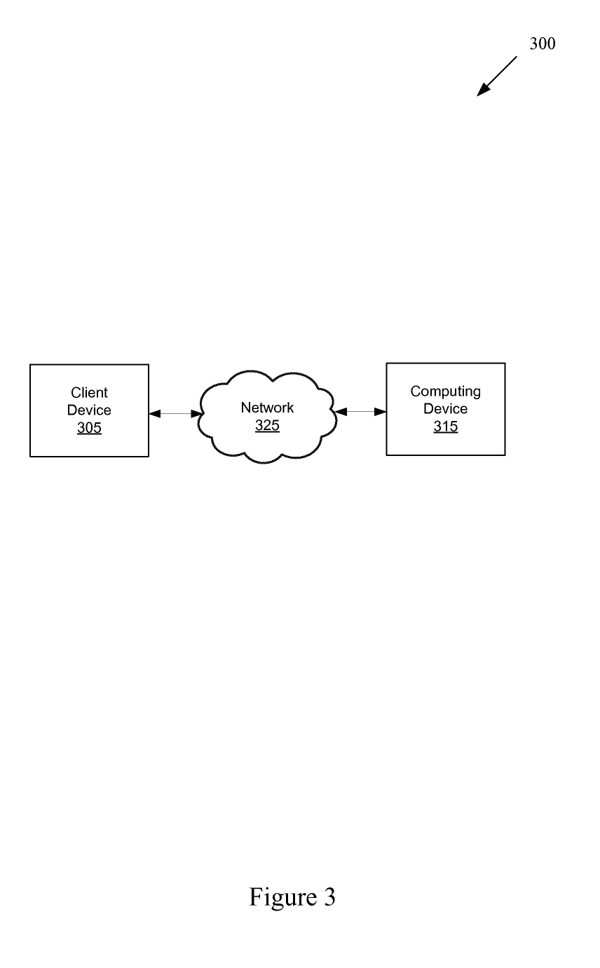

For example, referring now to FIG. 3, an example computing system 300 is shown. The computing system 300 includes a client device 305, a computing device 315, and a network 325.

The client device 305 can be a computing device, such as a desktop or laptop computer, or other devices such as a cellular telephone and/or smartphone. For example, the client device 305 can be a cellular telephone that is used by a user to submit a text message to receive a tracking code. The client device 305 can also be a computing device that is used by the supplier to initiate a campaign, by a retailer to track the progress of a campaign, or a user to track incentives.

The network 325 is any typical network that provides communication channels between the client device 305 and the computing device 315, such as the Internet, local area network, wide area network, and/or cellular network.

The computing device 315 is one or more computers that host the applications that provide the functions of the advertising system, such as campaign generation and maintenance. The computing device 315 can host one or more web sites that are accessible by the client device 305 using known protocols.

In example embodiments, the client device 305 and the computing device 315 each includes at least a processor, physical memory, and input/output devices. The memory includes computer-executable instructions, which when executed by the processor cause the processor to perform one or more of the methods described herein.

In an alternative embodiment, an application is provided for download by the user on the user's smartphone. This application allows for easy submission of tracking codes and tracking of the users incentives. For example, the application could interface with a smartphone camera, allowing the user to simply take a picture of the smart talker or other identifier of a campaign. The application could perform optical character recognition on the photograph to identify the relevant codes and automatically submit those codes to the advertising system.

In addition, the application could be programmed to receive the tracking code back from the advertising system and provide that information automatically to the retailer when the user buys the product. For example, the application can be programmed to generate a barcode on the display of the smartphone that could be read at the point-of-sale to obtain the necessary tracking information at time of purchase. Other configurations are possible.

As noted above, although the examples described above are provided in the context of the sale of beverages (e.g., alcoholic beverages), the principles described herein could be applied to other industries as well. For example, the advertising system could also be used for the marketing and sale of other consumer goods and services.

The various embodiments described above are provided by way of illustration only and should not be construed to limit the possible claims. Those skilled in the art will readily recognize various modifications and changes that may be made without following the example embodiments and applications illustrated and described herein.

What is claimed is:

1. A method for implementing an advertising campaign to sell alcoholic beverages, the method comprising:
receiving, at a computing device, a request from a user for a tracking code associated with a purchase of an alcoholic beverage;
generating the tracking code;
sending, by the computing device, the tracking code to the user;
receiving confirmation of the purchase of the alcoholic beverage; and
providing an incentive to the user for the purchase.

2. The method of claim 1, further comprising receiving a request from a supplier to create the advertising campaign.

3. The method of claim 1, further comprising allowing the user to create an online account to access the incentive.

4. The method of claim 1, further comprising allowing the user to use the incentive to purchase additional alcoholic beverages.

5. The method of claim 1, wherein the request for the tracking code is received by a text message.

6. The method of claim 1, wherein the tracking code is sent to the user in a text message.

7. The method of claim 1, further comprising collecting the tracking code from the user when the user purchases the alcoholic beverage.

8. The method of claim 1, further comprising receiving payment for the incentive from a supplier.

9. The method of claim 1, further comprising suggesting additional purchases to the user based on the user's location.

10. A method for implementing an advertising campaign to sell alcoholic beverages, the method comprising:
generating, by a computing device, a tracking code;
populating the tracking code in a device;
packaging the device with an alcoholic beverage;
receiving confirmation of a purchase of the alcoholic beverage by a user upon receipt of the tracking code; and
providing an incentive to the user for the purchase.

11. The method of claim 10, further comprising receiving a request from a supplier to create the advertising campaign.

12. The method of claim 10, further comprising allowing the user to create an online account to access the incentive.

13. The method of claim 10, further comprising allowing the user to use the incentive to purchase additional alcoholic beverages.

14. The method of claim 10, wherein the device is a ticket inserted into a packaging of the alcoholic beverage.

15. The method of claim 14, wherein the ticket is a scratch ticket.

16. The method of claim 10, further comprising suggesting additional purchases to the user based on the user's location.

17. The method of claim 10, further comprising receiving payment for the incentive from a supplier.

18. A method for implementing an advertising campaign to sell alcoholic beverages, the method comprising:
receiving a request from a supplier to create the advertising campaign;
receiving, at a computing device using text messaging, a request from a user for a tracking code associated with a purchase of an alcoholic beverage;
generating the tracking code;
sending, by the computing device using text messaging, the tracking code to the user;
receiving confirmation of the purchase of the alcoholic beverage;
providing an incentive to the user for the purchase; and
receiving payment for the incentive from the supplier.

19. The method of claim 18, further comprising allowing the user to create an online account to access the incentive.

20. The method of claim 18, further comprising allowing the user to use the incentive to purchase additional alcoholic beverages.
